(19) United States
(12) Patent Application Publication
(10) Pub. No.: US 2016/0140886 A1
(43) Pub. Date: May 19, 2016

(54) Yellow Fellow Safety Signs

(71) Applicant: Eddie Melvin Green, JR., (US)

(72) Inventor: Eddie Melvin Green, JR., Jeffersonville, IN (US)

(73) Assignee: Eddie Melvin Green, JR., Jeffersonville, IN (US)

(21) Appl. No.: 14/287,147

(22) Filed: May 26, 2014

(51) Int. Cl. G09F 19/22; G09F 13/22; G08B 5/38; G09F 15/00

(52) U.S. Cl. CPC G09F 19/22; G09F 15/0062; G09F 13/22; G08B 5/38; G09F 2013/222

(57) ABSTRACT

This is a unique wet floor safety sign that has the ability that no other wet floor signs has. It has the ability to give aid in early warning to the seeing impaired and to caution the unexpected person of a potential hazard by sounding a loud beeping sound or speaking a pre-recorded message. This wet floor sign also has flashing LED lights to help aid the hearing impaired when navigating their way around schools, stores, airports, shopping malls, and hospitals. By using an early warning system this will help in reducing the second leading cause of accidental deaths, the terrible slips, trips and falls.

The yellow fellow safety sign is a unique wet floor safety sign that has flashing LED lighting, a motion sensor with a beeper or voice box, moister sensor and a camera. This special product can only be activated with a special switch when it is opened and set out to view. It is design to pre-warn of potential dangers and will allow a person the extra time and attention needed to become aware of unseen conditions like potential wet floors.

### BACKGROUND OF THE INVENTION

1. Field of the Invention

this present invention relates to a verity of wet floor signs and safety systems, and particularly to the safety signs devices of active and Constance traffic areas such as hospitals, stores and schools.

2. Description of the Related Art

(2) Safety signs have been in existence for as long as there been all sorts of flooring, many of these floors surfaces have presented some unique problems with traction. Signs such as Pat. No. D260,780 issued to Maze et al., Pat. No. D328,615 issued to Taylor, Pat. No. D356,931 issued to Stover, Pa. No. D371,807 issued to Mandell et al., U.S. Pat. No. 4,253,260 issued to Maze et al., U.S. Pat. No. 4,298,186 issued to Glass, U.S. Pat. No. 4,796369 issued to Hamann, U.S. Pat. No. 4,928,415 issued to Walters, U.S. Pat. No. 4,974,815 issued to Glass, Pat. No. 4,977,697 issued to Genick, U.S. Pat. No. 4,999,937 issued to Bechtold, U.S. Pat. No. 5,003,912 issued to Thurston, U.S. Pat. No. 5,009,541 issued to Thurston, Pat. No. 5,046,885 issued to Thurston, U.S. Pat. No. 5,458,434 issued to Bent et al. although each of these patents outline effective and useful safety devices the use of the wet floor sign can be improved by providing a variety of wet floor safety signs that can accommodate different styles of flooring. Such devices would be in great demand in the market place. None of the above inventions and patents, taken either singularly or in combination is seen to describe the instant invention as claimed. Thus a wet floor safety sign device solving the afore mentioned problems is desired.

### SUMMARY OF THE INVENTION

The invention is a special wet floor safety sign with batteries and a motion sensor activated beeper with voice box, camera and a moisture sensor, also flashing lights to give pre-warning of a potential hazard ahead of time, the embodiments are as follows, the LED lights are white, or yellow, red, green, orange, purple, blue, pink, they are located on the front and back of the floor sign, the motion activated voice box is also located on the inside or the back side of the wet floor sign. It is the object of the invention to provide the hall ways and corridors and any floor with an added amount of safety by pre-warning the unexpected pedestrian of potential hazardous conditions. It is a further object of the invention to provide a loud beeping sound or too speak a pre-recorded warning to those who enter the area with caution. It is the object of the invention to provided improved elements and arrangements thereof for the purposes described which inexpensive dependable waterproof, shockproof and are fully effective in accomplishing its intended purpose. These and other objects of the present invention will become readily apparent upon further review of the following specification and drawings.

### BRIEF DESCRIPTION OF DRAWINGS

FIG. 1 is a plain wet floor sign.

FIG. 2 the off and on switch is depicted as S.

FIG. 3. Is a picture of a motion sensor depicted as MC.

FIG. 4 is a picture of a motion sensor activated voice box and beeper depicted as MS.

FIG. 5 is a picture of a camera depicted as C.

FIG. 6 is a picture of a battery pack depicted as BP.

FIG. 7 on the front panel F of the floor sign E is a depiction of the LED lighting described as LEDs.

FIG. 8 the back panel B of the floor sign E is a depiction of the LED lighting described as LEDs.

FIG. 9 is a picture of the front F of the floor sign E with a motion sensor activated voice box and beeper depicted as MS.

FIG. 10 is a picture of the back B of the floor sign E with a motion sensor activated voice box and beeper depicted as MS.

FIG. 11 is a picture of the front side F of the floor sign E with a moister sensor depicted as MC.

FIG. 12 is a picture of the back B of the floor sign E with a moister sensor depicted as MC.

FIG. 13 is a picture of the front side F of the floor sign E with a camera depicted as C.

FIG. 14 is a picture of the back side B of the floor sign E with a camera depicted as C.

FIG. 15 is a picture of the floor sign E with an off and on Switch depicted as S.

FIG. 16 is a picture of the front F of the floor sign E with all of the components, the off and on Switch depicted as S, motion sensor activated voice box and beeper depicted as MS, the moister sensor depicted as MC, the LED lighting depicted as LEDs, and camera depicted as C.

FIG. 17 is a picture of the back side B of the floor sign E with all of the components, the off and on Switch depicted as S, motion sensor activated voice box and beeper depicted as MS, the moister sensor depicted as MC, the LED lighting depicted as LEDs, and camera depicted as C.

FIG. 18 is an environmental perspective view of said components on the of floor sign panel E.

FIG. 19. Is a picture of a tube type floor sign T with LED lighting depicted as LEDs.

FIG. 20. Is a picture of a tube type floor sign T with a motion sensor depicted as MS.

FIG. 21 is an environmental perspective view of a tube type floor sign T with a battery pack depicted as BP.

FIG. 22 is a picture of a tube type floor sign T, with a moister sensor depicted as MC.

FIG. 23 is an environmental perspective view of a picture of the tube type floor sign T with said components, motion sensor depicted as MS, LED lighting depicted as LEDs, battery pack depicted as BP, and moister sensor depicted as MC.

### DETAIL DESCRIPTION OF PREFERRED EMBODIMENTS

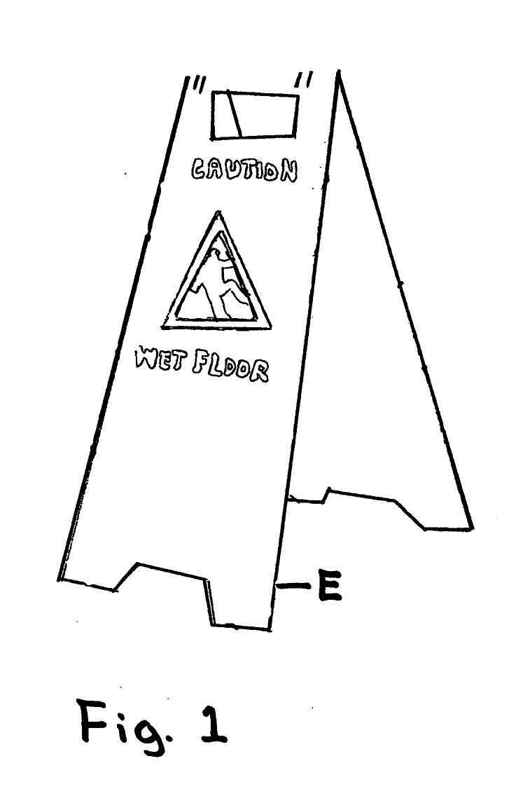

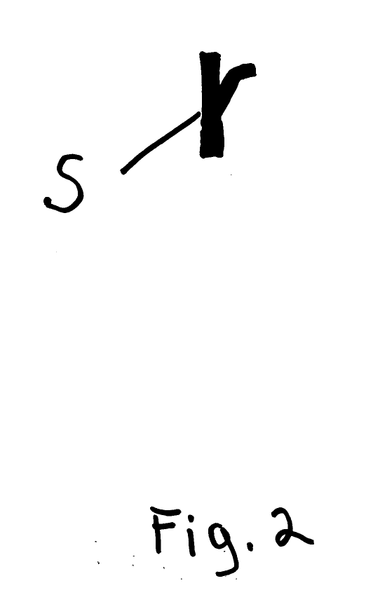

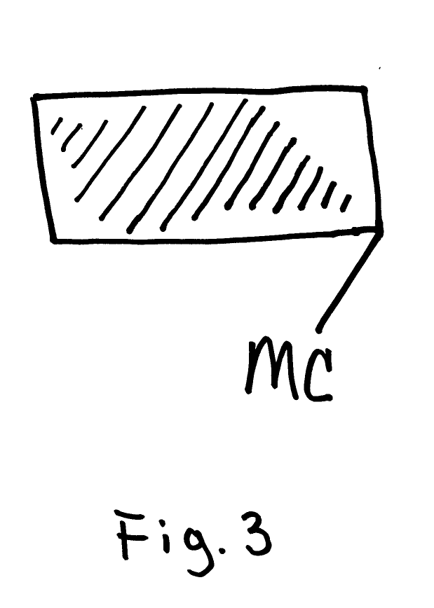

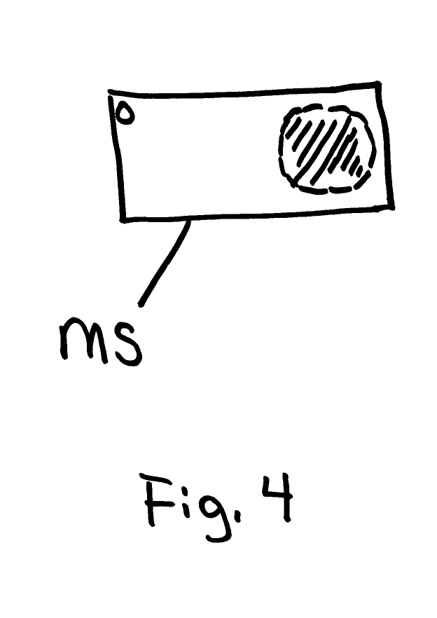

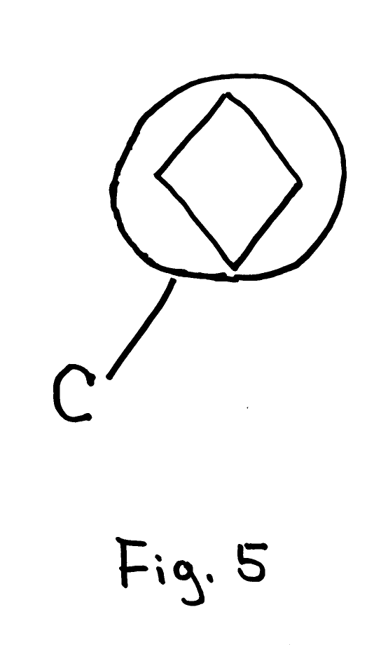

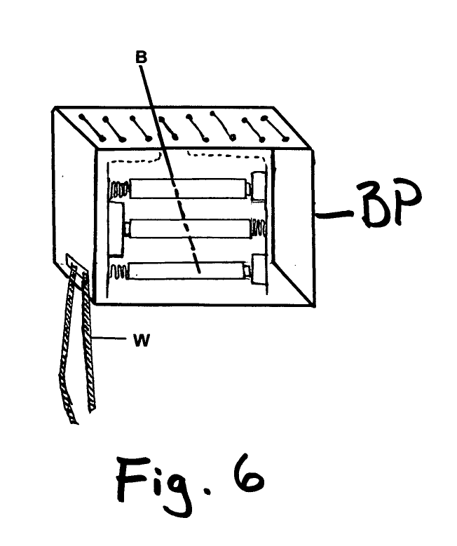

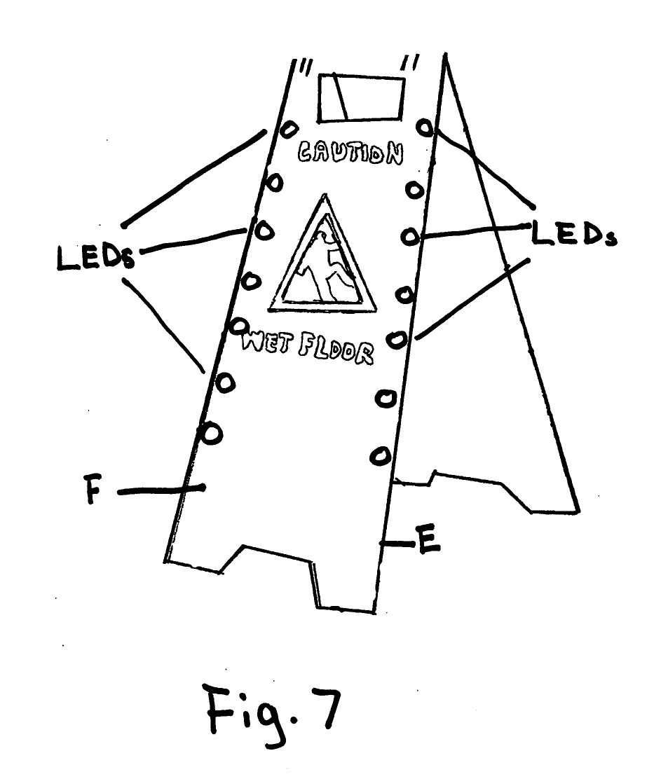

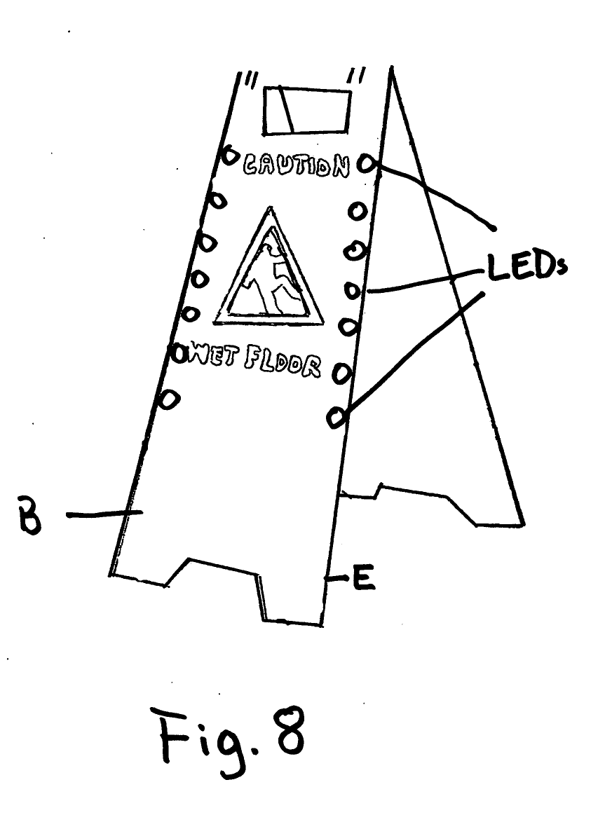

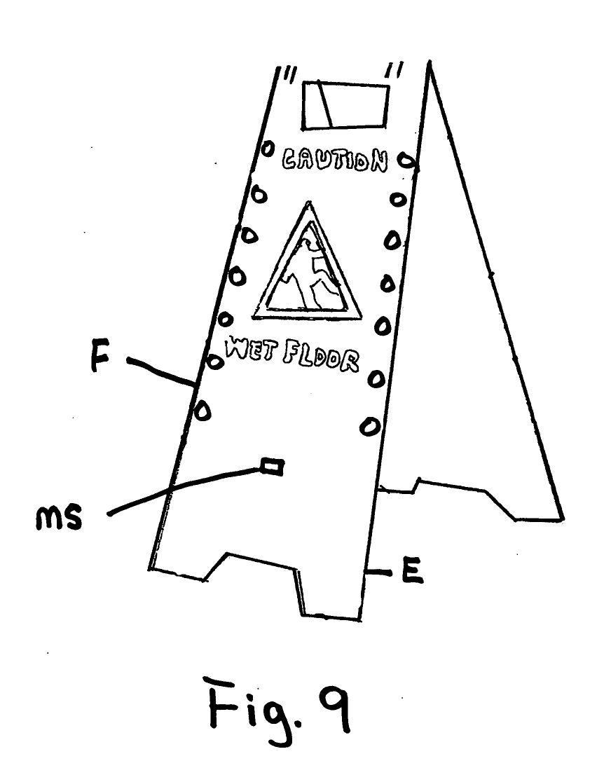

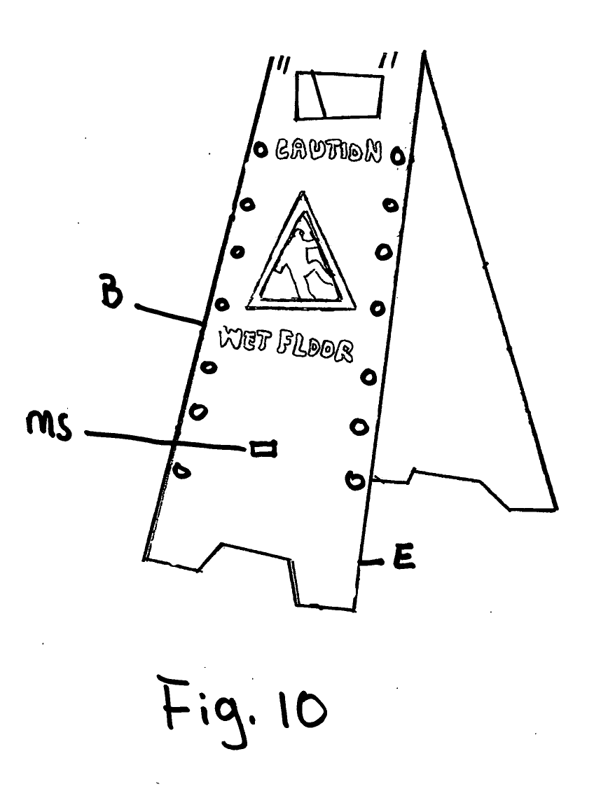

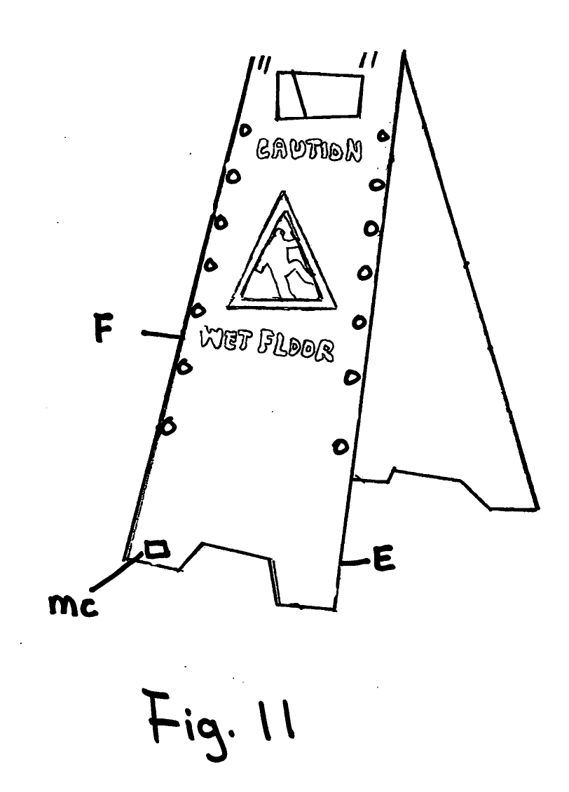

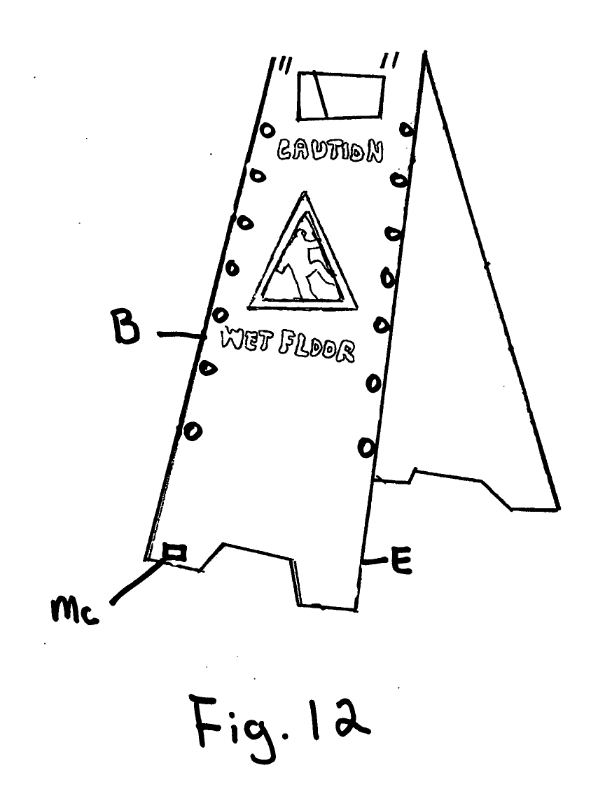

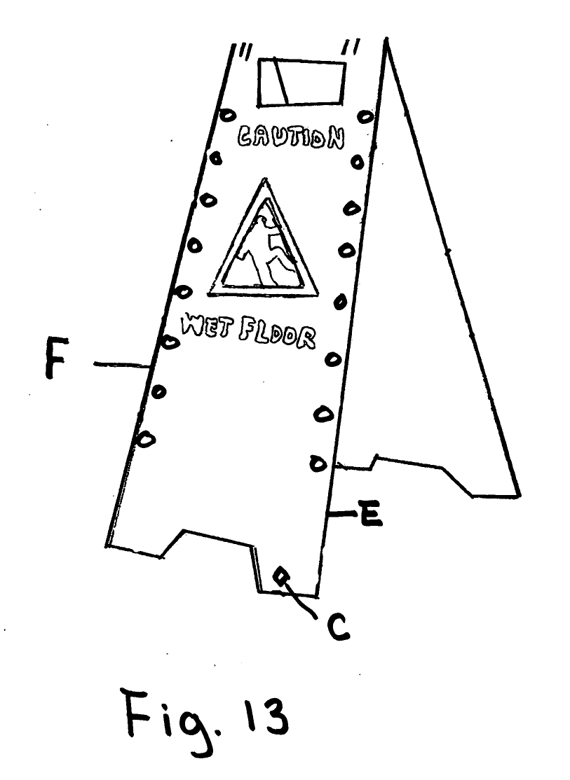

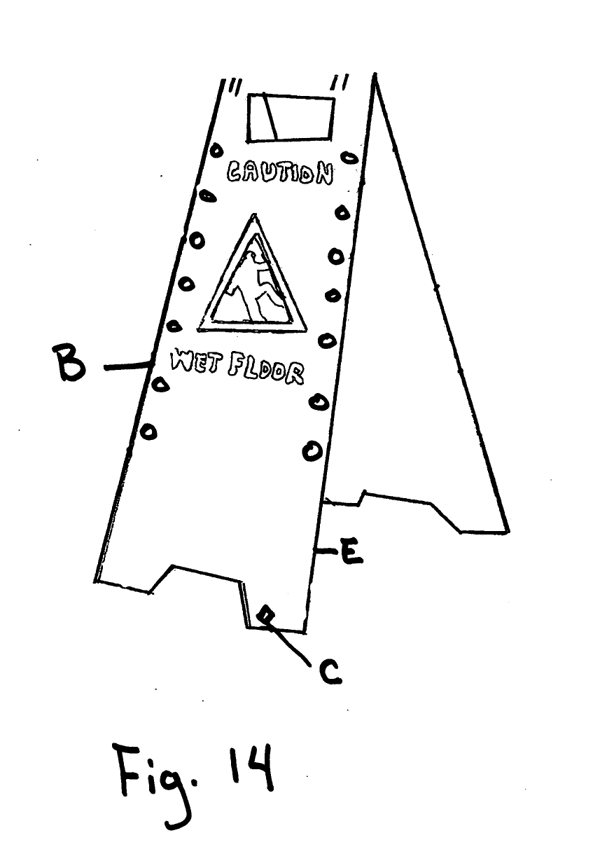

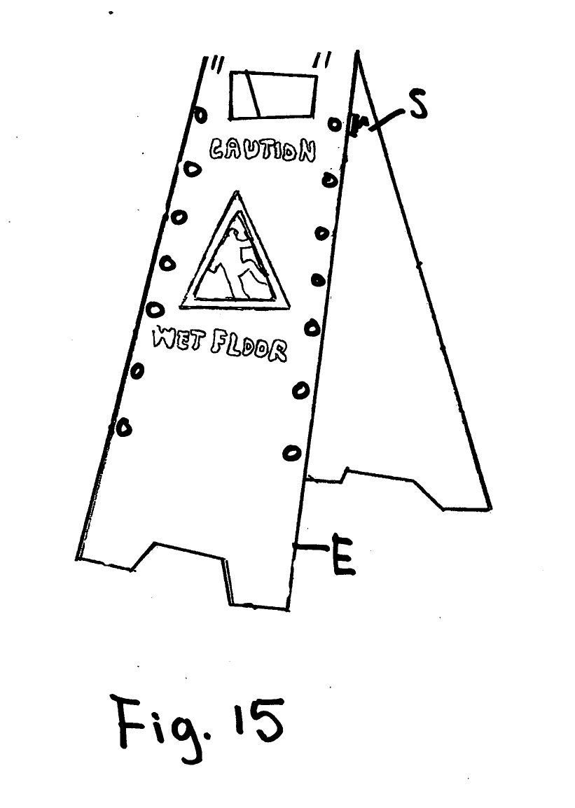

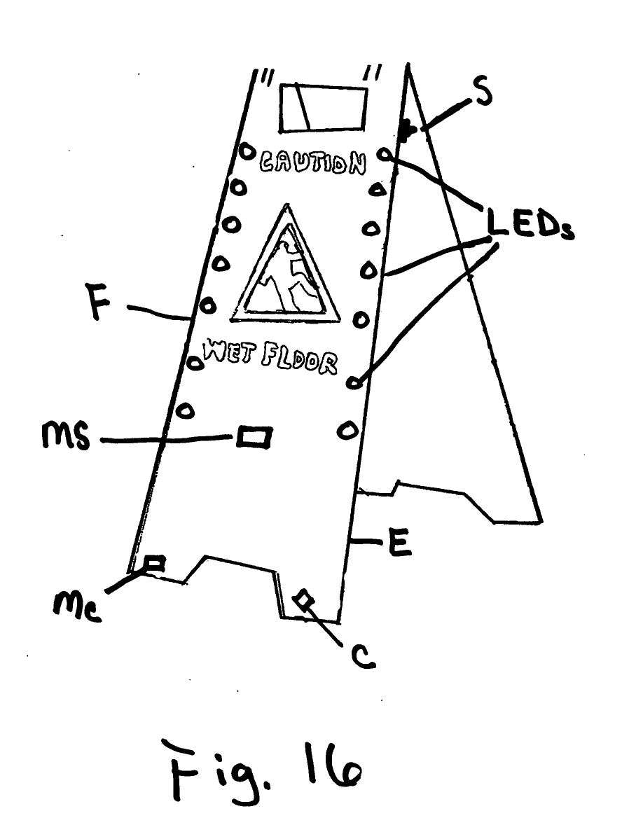

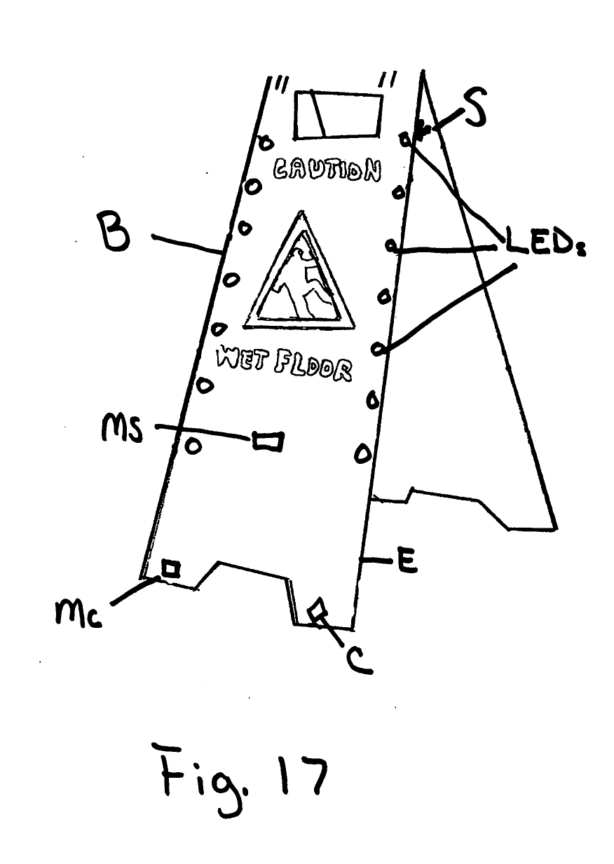

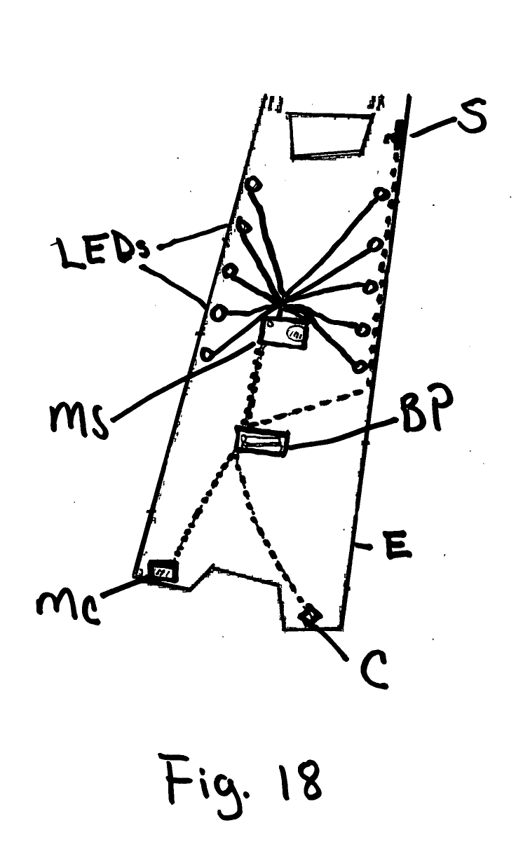

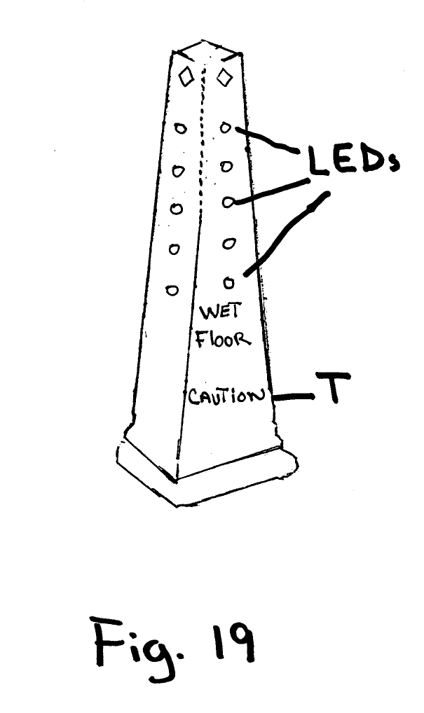

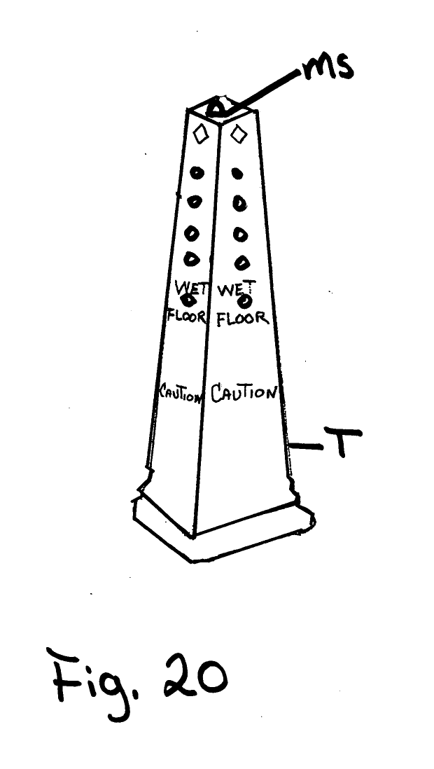

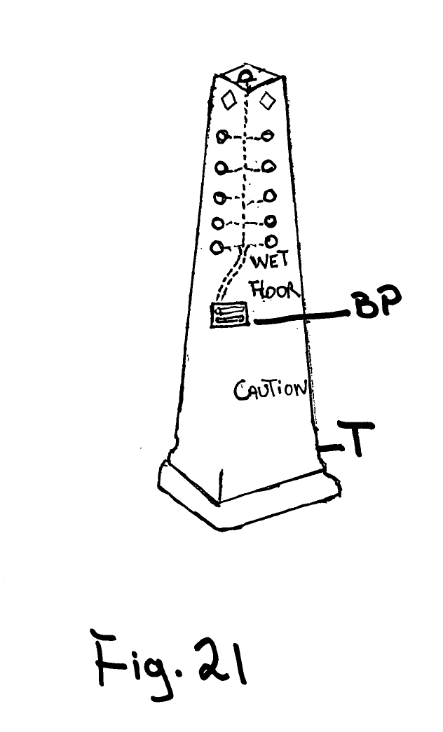

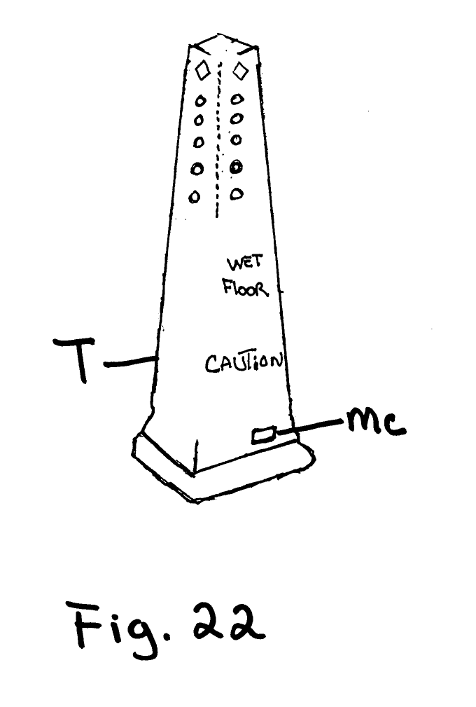

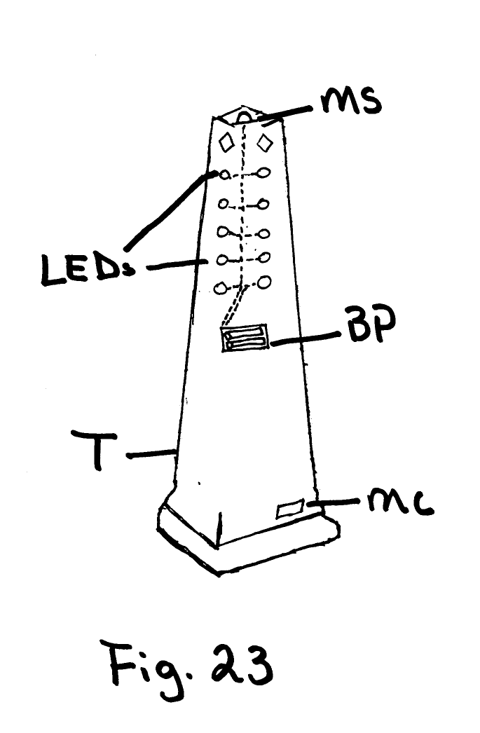

This present invention is a wet floor safety sign device E for hallways and corridors floors, with a battery pack BP and LED lights LEDs, motion sensor beeper activated voice box MS, camera C, and moister sensor MC. The first drawing of the wet floor sign E is depicted in FIG. 1 as a plain wet floor sign. As shown in FIG. 2 the off and on switch is depicted as S. As shown in FIG. 3. Is a picture of a motion sensor depicted as MC. As shown in FIG. 4 is a picture of a motion sensor activated voice box and beeper depicted as MS. As shown in FIG. 5 is a picture of a camera depicted as C. As shown in FIG. 6 is a picture of a battery pack depicted as BP. As shown in FIG. 7 on the front panel F of the floor sign E is a depiction of the LED lighting described as LEDs. As shown in FIG. 8 the back panel B of the floor sign E is a depiction of the LED lighting described as LEDs. As shown in FIG. 9 is a picture of the front F of the floor sign E with a motion sensor activated voice box and beeper depicted as MS. As shown in FIG. 10 is a picture of the back B of the floor sign E with a motion sensor activated voice box and beeper depicted as MS. As shown in FIG. 11 is a picture of the front side F of the floor sign E with a moister sensor depicted as MC. As shown in FIG. 12 is a picture of the back B of the floor sign E with a moister sensor depicted as MC. As shown in FIG. 13 is a picture of the front side F of the floor sign E with a camera depicted as C. As shown in FIG. 14 is a picture of the back side B of the floor sign E with a camera depicted as C. As shown in FIG. 15 is a picture of the floor sign E with an off and on Switch depicted as S. As shown in FIG. 16 is a picture of the front F of the floor sign E with all of the components, the off and on Switch depicted as S, motion sensor activated voice box and beeper depicted as MS, the moister sensor depicted as MC, the LED lighting depicted as LEDs, and camera depicted as C. As shown in FIG. 17 is a picture of the back side B of the floor sign E with all of the components, the off and on Switch depicted as S, motion sensor activated voice box and beeper depicted as MS, the moister sensor depicted as MC, the LED lighting depicted as LEDs, and camera depicted as C. As shown in FIG. 18 is an environmental perspective view of said components on the panel of floor sign E. As shown in FIG. 19. Is a picture of a tube type floor sign T with LED lighting depicted as LEDs. As shown in FIG. 20. Is a picture of a tube type floor sign T with a motion sensor depicted as MS. As shown in FIG. 21 is an environmental perspective view of a tube type floor sign T with a battery pack depicted as BP. As shown in FIG. 22 is a picture of a tube type floor sign T, with a moister sensor depicted as MC. As shown in FIG. 23 is an environmental perspective view of a picture of the tube type floor sign T with said components, motion sensor depicted as MS, LED lighting depicted as LEDs, battery pack depicted as BP, and moister sensor depicted as MC.

I claim,

1. (canceled)

2. A durable, waterproof, shockproof wet floor safety sign device comprising ; an automatic on and off switch operatively coupled to a power supply, a solar charged battery pack coupled to a motion sensor, a video camera operatively coupled to the power supply, a voice box with a warning message operatively coupled to the motion sensor circuit, a moisture sensor circuit operatively coupled to the timing circuit, a multiple flashing warning light circuit being adapted to produce a trigger signal and communicate said trigger signal to the timing circuit when wet conditions are sensed, said timing circuit being adapted to produce an activation signal and communicate said activation signal to the voice box circuit and flashing warning lights circuit upon receiving a trigger signal from the moisture sensor circuit, said voice box circuit being adapted to produce an audible warning message output corresponding to the flashing warning lights circuit message upon receiving an activation signal from said timing circuit.

3. A wet floor safety sign with an automatic on and off switch according to claim 1, said switch further comprising and operably coupled to the wet floor safety sign and configured to enable activation and deactivation of the product when in use.

4. A wet floor safety sign with a self-contained solar charged battery pack module according to claim 1, said solar charged battery pack further comprising of batteries configured to enable recharging without repeatedly replacing batteries.

5. A wet floor safety sign with a self-contained motion sensitive sensor device according to claim 1, said motion sensitive sensor device further comprising and coupled to the audio circuit and flashing lights circuit configured to produce a warning message corresponding to the audible output.

6. A wet floor safety sign with a self-contained moisture sensor circuit according to claim 1, said module further comprising a super sensitive device that detects a selective degree of moisture operably coupled to the audio circuit and flashing lights circuits configured to produce a visible illumination during the audible sign message output.

7. A wet floor safety sign that are durable according to claim 1, said safety sign further comprising of hard plastic materials able to exist for a long time without significant deterioration.

8. A wet floor safety sign that is waterproof according to claim 1, said safety sign further comprising and impervious to water.

9. A wet floor safety sign that is shockproof according to claim 1, said safety sign further comprising and designed to resist damage when dropped or knocked down.
